(19) United States
(12) Patent Application Publication
(10) Pub. No.: US 2008/0056194 A1
(43) Pub. Date: Mar. 6, 2008

(54) System for combining uplink data blocks from a user with transmission pauses from another user

(76) Inventors: Ilya O. Gonorovsky, Staten Island, NY (US); Stephen A. Howell, Gloucester (GB); Jian J. Wu, Reading (GB)

Correspondence Address: BRINKS HOFER GILSON & LIONE, P.O. BOX 10395, CHICAGO, IL, 60610, US

(21) Appl. No.: 11/514,409

(22) Filed: Aug. 29, 2006

(51) Int. Cl. H04Q 7/00

(52) U.S. Cl. 370/331

(57) ABSTRACT

A dual transfer mode communications network (100), such as a GSM network using AMR and GPRS data transmission modes, allows enhanced data utilization efficiency by multiplexing AMR pauses generated during speech frame transmission by a first mobile system (101) with short packet-switched data bursts from a second mobile system (105). The communications network (100) processes an access request burst signal on an uplink channel from the first mobile system (101) along with the short packet-switched data bursts from the second mobile system (105).

### BACKGROUND

The invention relates to dual mode radio communication systems. In particular, the invention relates to uplink packet utilization in (E) General Packet Radio Service (EGPRS) systems.

General Packet Radio Service (GPRS) is a mobile data service available to users of GSM mobile phones. It is often described as “2.5G”, that is, a technology between the second (2G) and third (3G) generations of mobile telephony. GPRS provides moderate speed data transfer, by using TDMA channels in the GSM network. EDGE Radio Access Network is an advanced GPRS system protocol that can be used for any packet switched applications such as an Internet connection. High-speed data applications such as video services and other multimedia benefit from increased data capacity.

Adaptive Multi-Rate (AMR) is an audio data compression scheme optimized for speech coding. AMR is adopted as the standard speech codec by 3GPP. The codec has eight bit rates, 12.2, 10.2, 7.95, 7.40, 6.70, 5.90, 5.15 and 4.75 kbit/s. The bitstream is based on frames, which contain 160 samples and are 20 milliseconds long. AMR uses different techniques, such as Algebraic Code Excited Linear Prediction (ACELP), Discontinuous Transmission (DTX), voice activity detection (VAD) and comfort noise generation (CNG).

When using a mobile device to transmit speech frames, an AMR module will transmit pauses when the speaker pauses during speech. Conventionally, the AMR's pauses from the user could be used by the same user only and if a mobile device supports dual transfer mode (DTM) (circuit-switched (CS) and packet-switched (PS) on the same slot) and if the PS and CS (AMR) services are activated simultaneously, which is not usual case for the most of the time. Taking into account that the average time duration for the pauses from each participating in the conversation users is about 50%, it would be very desirable if a GSM EDGE Radio Access Network (GERAN) would allow use of the AMR's pauses from one user to be used by the another user filling them with GPRS blocks on the uplink direction. It would give a significant increase to the capacity for the GERAN systems in the uplink direction. At the same time it may be possible for the network in a GERAN system to multiplex (combine) the AMR's pauses on the downlink direction from one user with the GPRS blocks on the downlink direction from another user, because the network knows exactly when the pause has started and when it has finished.

### BRIEF DESCRIPTION OF THE DRAWINGS

Embodiments of the present invention are now described, by way of example only, with reference to the accompanying figures in which:

FIG. 1 illustrates an example DTM network.

FIG. 2 illustrates an example communication device

FIG. 3 illustrates an example sequence of packet block transmissions.

FIG. 4 illustrates an example access burst packet structure.

FIG. 5 illustrates an example AMR Access Burst.

FIG. 6 illustrates example frames in a short (E)GPRS block.

FIG. 7 illustrates an example mapping between a conventional (E) GPRS block and a modified (E) GPRS block.

FIG. 8 illustrates a process that combines the (E) GPRS uplink data blocks from one user with the AMR pause periods from another user.

FIG. 9 illustrates an example schematic transmission sequence using an example DTM network.

FIG. 10 illustrates a second example schematic transmission sequence using an example DTM network.

FIG. 11 illustrates example transmission sequences for three users.

### DETAILED DESCRIPTION

The present disclosure is defined by the appended claims. This description summarizes some aspects of the present embodiments and should not be used to limit the claims.

While the present disclosure may be embodied in various forms, there are shown in the drawings and will hereinafter be described some exemplary and non-limiting embodiments, with the understanding that the present disclosure is to be considered an exemplification of the disclosure and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a and an” object is intended to denote also one of a possible plurality of such objects.

Packet-switched data under GPRS is achieved by allocating bandwidth to transmit data. As dedicated (voice or data) channels are setup by phones, the bandwidth available for packet switched data shrinks. The theoretical limit for packet switched data is approximately 160.0 kbit/s (using 8 time slots and CS-4). A realistic bit rate is 30-80 kbit/s, because currently it is possible to use a maximum of 4 time slots for downlink. A change to the radio part of GPRS called (E) GPRS allows higher bit rates of between 160 and 236.8 kbit/s. The maximum data rates are achieved only by allocation of more than one time slot in the TDMA frame. Also, the higher the data rate, the lower the error correction capability. Generally, the connection speed drops logarithmically with distance from the base station. This is not an issue in heavily populated areas with high cell density, but may become an issue in sparsely populated/rural areas.

Various coding modes may be used in AMR depending on external conditions. If a channel is of poor quality, source coding is reduced and channel coding is increased. This improves the quality and robustness of the network. With AMR, this improvement is approximately 4-6 dB S/N for communication. The usage of AMR requires optimized link adaptation that selects the best codec mode to meet the local radio channel and capacity requirements.

A communications system is disclosed for a DTM network that uses the AMR pauses of transmitting mobile device with GPRS short data bursts of a second mobile device. The communications system includes a first mobile system, a second mobile system, and a network node operable to multiplex an access request burst signal, during an uplink session of a circuit-switched channel, with a short packet-switched data burst associated with a second mobile system, at an end of a pause period from a first mobile system. In a preferred embodiment, the first mobile system includes an AMR speech coding system. In another preferred embodiment, the second mobile system is operable to transmit the short packet-switched data burst during a pause period of the first mobile system.

A DTM communications network is disclosed for utilizing AMR pauses to increase transmission efficiency. The network includes a plurality of mobile systems, where the plurality of mobile systems include a transmitting mobile system and a requesting mobile system. The mobile systems are operable to transmit an access request burst signal at an end of a pause period during an uplink session of a circuit-switched data sequence, and transmit a short packet-switched data burst associated with the communications device during a pause period of the transmitting mobile system. The network includes a base station operable to allocate a transmission channel from the transmitting mobile system to the requesting mobile system during the pause period of the transmitting mobile system, and multiplex the access request burst with the short packet-switched data burst at the end of the pause period.

A method that utilizes transmission capacity for a DTM communications device is disclosed. The method includes transmitting an AMR frame by a transmitting mobile system, transmitting an access request burst signal by a requesting mobile system on an uplink, at an end of a pause period during an uplink session, and transmitting a short data burst associated with a mobile system transmitting packet-switched data during a pause period of a transmitting mobile system.

A method that utilizes transmission capacity for a DTM communications network is also disclosed. The method includes transmitting an AMR frame by a transmitting mobile system, and transmitting an access request burst signal by a requesting mobile system at an end of a pause period during an uplink session. A transmission channel is allocated from the transmitting mobile system to the requesting mobile system during the pause period of the transmitting mobile system, based on the access request burst signal, and a short packet-switched data burst associated with the DTM communications device is transmitted during a pause period of a transmitting mobile system. The DTM communications network multiplexes the access request burst signal with the short packet-switched data burst by a DTM network node at the end of the pause period.

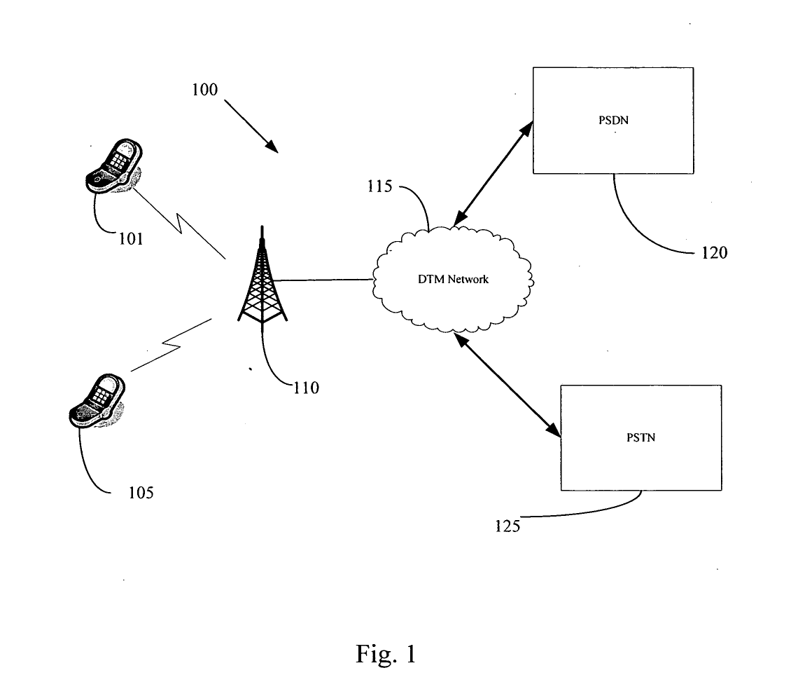

FIG. 1 illustrates an example schematic block diagram of a wireless communications network 100, such as a GPRS network. The wireless communications network includes a plurality of wireless communication device (mobile systems, or MS) 101 and 105, a base transceiver station (BS) 110, a GSM network 115, a Public Switched Data Network (PSDN) 120, and a Public Switched Telephone Network (PSTN) 125.

The MS 101 and 105 may be a cellular telephone configured to operate with the GERAN protocol, or other DTM protocols. The MS 101 and 105 may include other devices that transmit and receive data signals interoperable with the GERAN protocol.

The BS 110 is the section of the network 100 that handles traffic and signaling between a mobile phone and a Network Switching Subsystem, such as the GERAN network 115. The BS 110 transcodes signals, controls speech channels, allocates radio channels to mobile phones, handles paging, manages quality management of transmission and reception over the air interface, and processes many other tasks related to the radio network.

The BS 110 contains radio frequency transmitters and receivers used to communicate directly with the MS 101 and 105. In this type of cellular network, the MS's 101 and 105 cannot communicate directly with each other but have to communicate with the BS 110.

The GERAN network 115 includes components that connect the wireless communication device 101 and 105 and the BS 110 with other components, such as the PSDN 120 and the PSTN 125. The GERAN network 115 includes support nodes, servers, and gateways operable to transmit the data carried within the GERAN network 115 and between the wireless communication device 101 and 105 and the PSDN 120 and the PSTN 125.

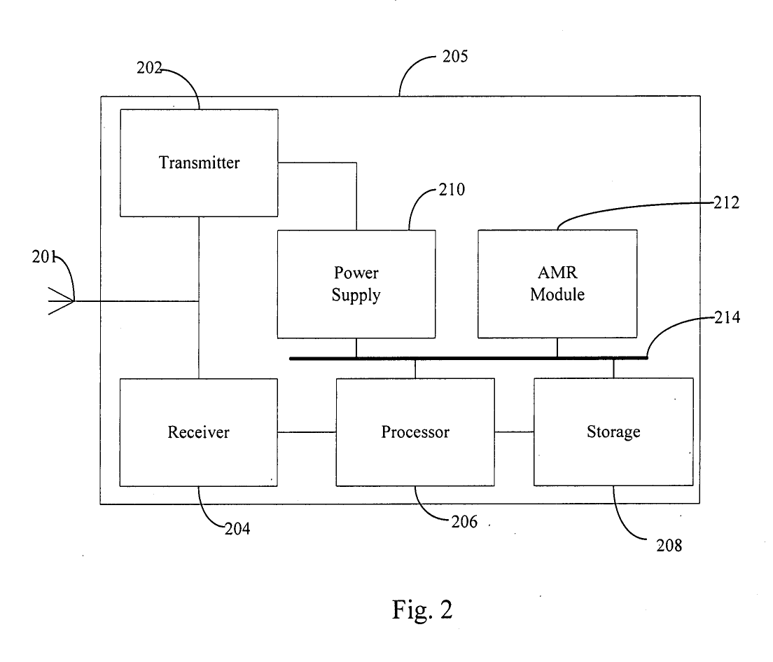

FIG. 2 illustrates a schematic block diagram of an example wireless communication device 101 or 105. The wireless communication device 101 includes an antenna 201, a transmitter 202, a receiver 204, a processor 206, a storage 208, a power supply 210, and an AMR module 212. In an exemplary embodiment, the antenna 201 may be coupled to both the transmitter 202 and the receiver 204, or the transmitter 202 and the receiver 204 may be connected to respective antenna units. In another exemplary embodiment, the processor 206, the storage 208, the power supply module 210, and the AMR module 212 are coupled to each other through a communications bus 214. The communications bus 214 is operable to transmit control and communications signals from and between the components connected to the bus 214, such as power regulation, memory access instructions, channel control, and other system information. The processor 206 is coupled to the receiver 204, and the transmitter 202 is coupled to the receiver 204 and to the processor 206.

The processor 206 is configurable to format and create packets of data to transmit using the transmitter 202. In an exemplary embodiment, the processor 206 interfaces with the AMR module 212 to determine when pauses are transmitted by the MS 101 and 105. The processor 206 determines when to transmit speech identification frames, speech identification update frames, access request burst signals, and packet-switched data frames.

The power supply 210 provides power to the components for the MS 101 and 105. In an exemplary embodiment, the power supply 210 is controlled by the processor 206 to increase or decrease power to the transmitter 202. The power supply 210 may include power conditioning and power filtering components operable to ensure a smooth power signal to the transmitter 202. The storage 208 stores data required for operation of the MS 101 and 105, channel initialization parameters, and other data used by the processor 206 for operation under GERAN or other DTM protocols. The storage 208 may store other data, such as data packets to be transmitted by the MS 101 and 105, data packets received by the receiver 204, or buffered data that is retrieved by the processor 206.

The AMR module 212 provides audio data compression for speech coding. The codec has eight bit rates, 12.2, 10.2, 7.95, 7.40, 6.70, 5.90, 5.15 and 4.75 kbit/s. The bitstream is based on frames which contain 160 samples and are 20 milliseconds long. AMR uses different techniques, such as Algebraic Code Excited Linear Prediction (ACELP), Discontinuous Transmission (DTX), voice activity detection (VAD) and comfort noise generation (CNG). In an exemplary embodiment, the AMR module 212 provides speech identification data, compressed speech data, and pause information to the processor 206.

On the downlink channel, combining of the GPRS downlink data blocks from one user with the AMR's pauses periods from another user may be based on the ability of the BS 110 to coordinate which information (AMR or GPRS) the BS 110 would transmit to the MS 101, which is associated with AMR, or to the MS 105, which is associated with GPRS service. On the uplink channel, with two uncorrelated MS's 101 and 105 intended to share the same particular slot at the particular block time, collisions may occur.

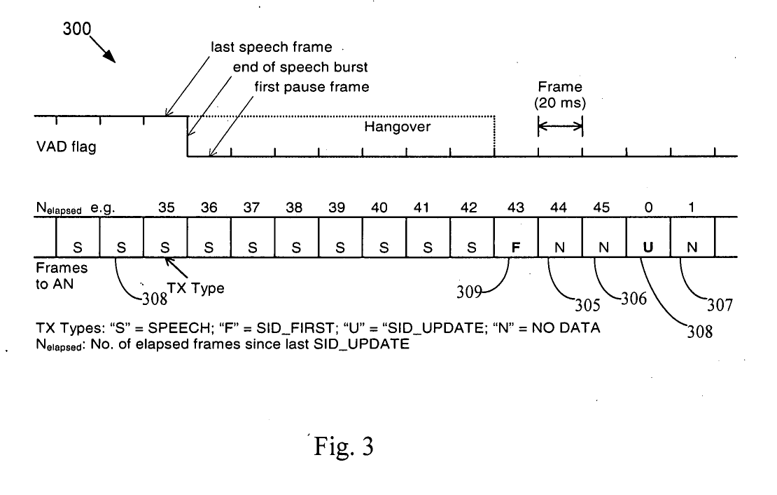

FIG. 3 illustrates an example sequence of packet block transmissions 300 from an MS 101. All marked “N” blocks (305, 306, and 307) are not used, but instead they may be wasted and therefore decrease the capacity of the network.

Because the AMR Frames (such as speech (S) 308, SID 309, SID updates (U) 309, and N (305-307)) and GPRS blocks have the same 20 ms duration, the GERAN network 100 allows multiplexing the request to resume the “S” frames 308 from one user and a GPRS block from another user. To allow this multiplexing, an “AMR Access Burst” (AAB) and a “Short GPRS block” are introduced in this disclosure in GERAN network communications. The “AMR Access Burst” (AAB) is the access request that would be transmitted by the MS 101 or 105 using AMR service at the end of the pause period. The AAB is used to request the channel back to the MS 101 for further communications.

The short GPRS block is the block associated with the MS 105 using the PS service, where the MS 105 would be transmitting on the borrowed channel (N blocks) from another MS 101, which is using the AMR service, but is paused.

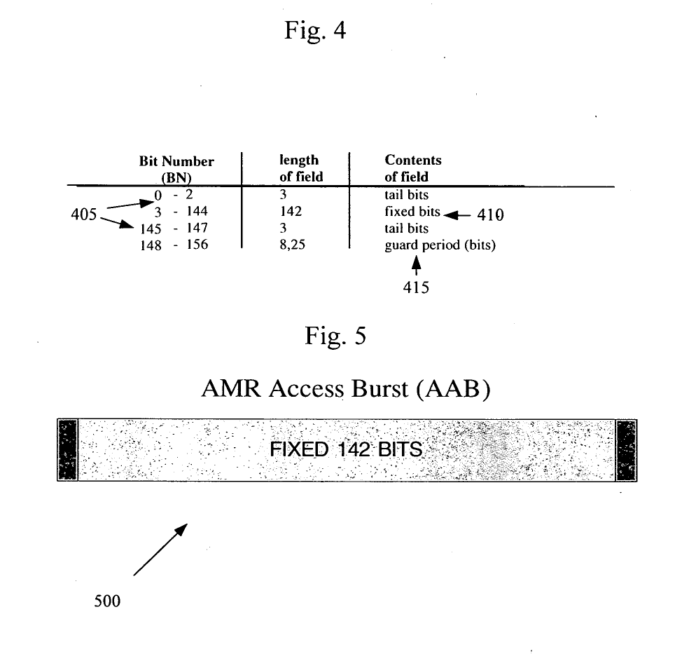

FIG. 4 illustrates the AAB packet structure. The packet comprises a number of “tail bits” 405, a fixed number of bits comprising the AAB 410, and a guard period 415. In a GERAN system, the synchronization of the mobile phones is achieved by sending timing advance commands from the base station which instructs the mobile phone to transmit earlier and by how much. This compensates for propagation delay. The mobile device is not allowed to transmit for its entire timeslot, because there is a guard interval at the end of each timeslot. As the transmission moves into the guard period, the mobile network adjusts the timing advance to synchronize the transmission.

The “tail bits” 405 at either end of the burst delimit the beginning and/or end of the burst and assist in the equalization of the data message portion of the signal. The “tail bits” are defined as modulating bits with states as follows:

(BN0, BN1, BN2)=(0, 0, 0) and

(BN145, BN146, BN147)=(0, 0, 0)

where the “fixed bits” 410 are defined as modulating bits containing AAB signal information, with states as follows:

(BN3, BN4 . . . BN144)=(0, 0 . . . 0)

A Frequency Correction Burst (FCB) is used for frequency synchronization of the mobile, for the downlink channel. The FCB defines the Frequency Control Channel (FCCH) which is assigned to every other timeslot. The FCB is 142 bits long, but carries no information. It is equivalent to an unmodulated carrier, shifted in frequency, with the same guard time as the normal burst. The FCB identifies the FCCH and allows the synchronization Channel (SCH) to be found at Ts 0 of the following 51-multiframe.

The Compact FCB may be equivalent to an unmodulated carrier with a +1 625/24 kHz frequency offset, above the nominal carrier frequency.

FIG. 5 illustrates the AAB data structure 500. The AAB 500 is a fixed 142 bits within the AAB packet structure. In an exemplary embodiment, the AAB 500 is a replica of the Frequency Correction Burst (FB), which is being used by GERAN networks on the downlink direction only, while the AAB 500 would be used by the MS 101 on the uplink direction only. The AAB 500 is determined such that it has a low average correlation over the possible data values of the user data. In one exemplary embodiment, the AAB 500 comprises a substantially sinusoidal signal. Sinusoidal waves provide good average correlation properties, do not generate spurious signal properties, and may be detected reliably.

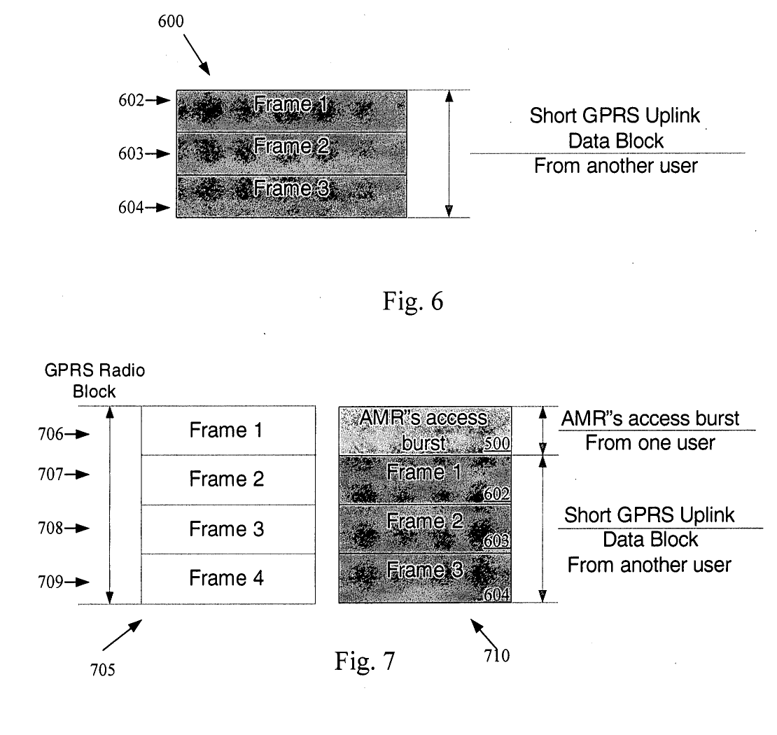

FIG. 6 illustrates frames in a short (E)GPRS block 600. The “Short (E) GPRS block” is a block that is built from three TDMA frames 602, 603, and 604. A conventional (E) GPRS block is built from four TDMA frames. A conventional GPRS TDMA frame comprises a Media Access Control (MAC) header, a Radio Link Control RLC/MAC control block or an RLC data block, and a Block Check Sequence.

FIG. 7 illustrates an example mapping between the conventional GPRS block 705 and the short GPRS block 710. In an exemplary embodiment, a first frame 602 of the short GPRS block 710 maps to a second frame 707 of the conventional GPRS block 705. A second frame 603 of the short GPRS block 710 maps to a third frame 708 of the conventional GPRS block 705. A third frame 604 of the short GPRS block 710 maps to a fourth frame 709 of the conventional GPRS block 705.

The mapping illustrated in FIG. 7 allows space for the AMR Access Burst. In an exemplary embodiment, the AAB 500 maps to a first frame 706 of the conventional GPRS block 705, where the AAB 500 is multiplexed with the Short GPRS Block 710.

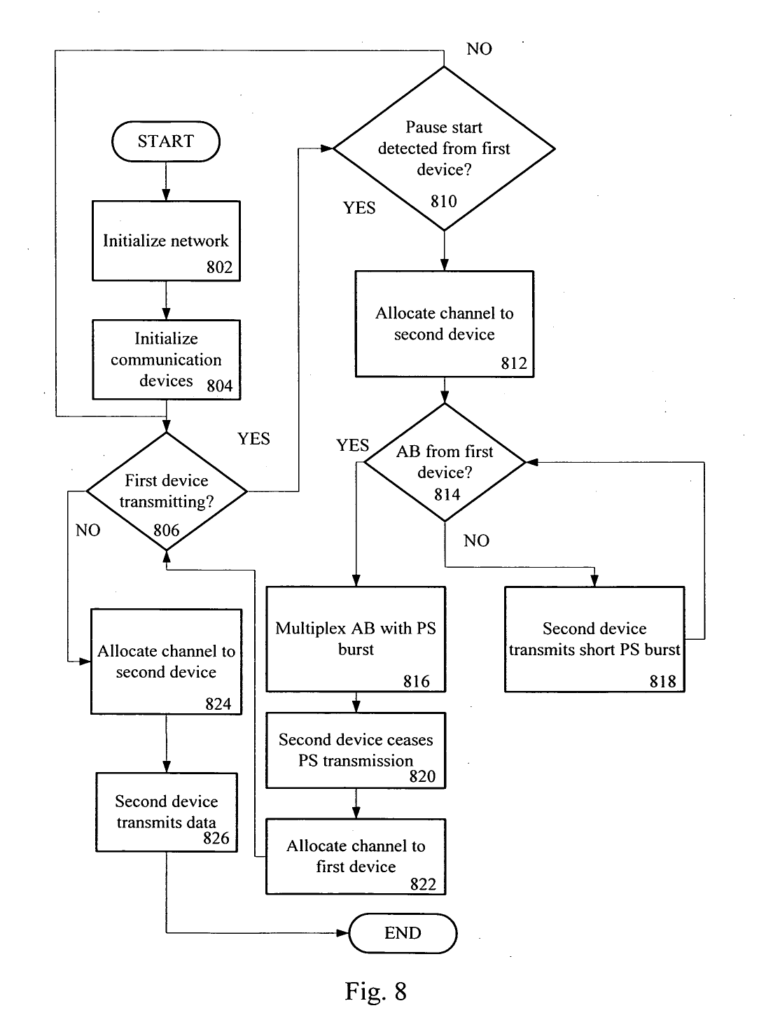

FIG. 8 illustrates a process that combines the (E)GPRS uplink data blocks from one user with the AMR pause periods from another user. A DTM network, such as a (E)GPRS network, may initialize network parameters and variables, at step 802. The GPRS network may locate and acquire communication devices, determine transmission capabilities, allocate initial channel distributions, determine power requirements, initialize connections between base stations, communication devices, and other network components, or perform other network initialization functions. The communication devices may then initialize, at step 804. The communication device may start-up, acquire a connection to a base station, load initialization parameters from a memory resident in the communication device, determine power requirements, determine network data transfer modes or capabilities, or other initialization processes.

The base station determines if a first communication device is transmitting speech data, such as speech data frames, at step 806. A base station may determine if a channel has been allocated to the first communication device and if the first communication device is transmitting speech data frames.

If the first communication device is transmitting speech data frames, the base station determines if the first communication device has started a pause in its AMR speech frame transmissions, such as by transmitting a first speech identification frame (SID_First), at step 810. If the base station does not detect a pause start, control returns to step 806 to process the first communication device transmissions.

If the first communication device indicates it is starting a pause in its AMR speech frames, the base station allocates the transmission channel to the second communication device, at step 812. The base station then determines if an access burst (AB), such as an AMR access burst (AAB) has been transmitted in an uplink channel by the first communication device, at step 814, indicating that the first communication device has finished a pause in its speech data transmissions. If the base station determines that the first communication device has transmitted an AB, where the first communication device is requesting allocation of the communication channel for AMR speech transmissions, then the base station multiplexes the AB with a packet-switched burst packet, such as a GPRS short burst packet, at step 816.

The GPRS short block comprises three frames of GPRS data in TDMA slots. The first frame of the short frame must be mapped into second frame of the conventional GPRS block, the second frame of the short block must be mapped into third frame of the conventional GPRS block and the third frame of the short block must be mapped into fourth frame of the conventional GPRS block. This mapping allows space for the AAB (which must be mapped with the first frame of the conventional GPRS block) to be multiplexed with the short GPRS block.

If the first communication device has not transmitted an AB, the second communication device transmits, in an uplink channel, a number of short GPRS burst packets, at step 818. The second communication device transmits the short GPRS burst packets until the first communication device transmits an AB, requesting the channel back for AMR transmission. After the multiplexed AB and short GPRS burst, the base station commands the second communication device to cease transmission of PS packets, at step 820, and the channel is allocated to the first communication device, at step 822. After the speech session from the first device is finished (not paused), the base station may then allocate the channel to a different communication device in the network, such as the second communication device or other communication device, at step 824. The second communication device, for example, may then transmit data, such as AMR speech frames or packet-switched data, at step 826.

A GERAN or any DTM network may more efficiently use network bandwidth by multiplexing the AAB of the first communication device with the short GPRS bursts of the second communication device. In this case, the unused pause time from the first communication device is used by the second communication device to transmit (E) GPRS data packets until the pause period of the first communication device ends.

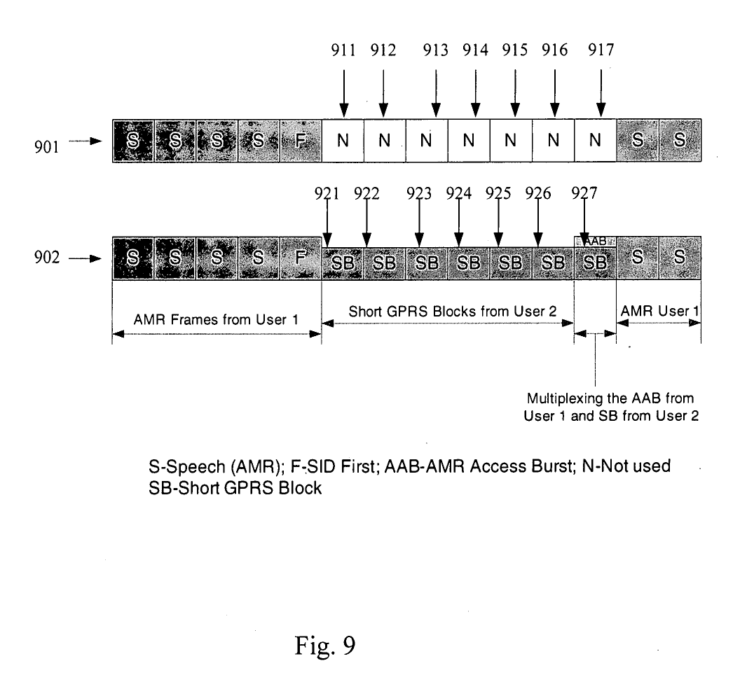

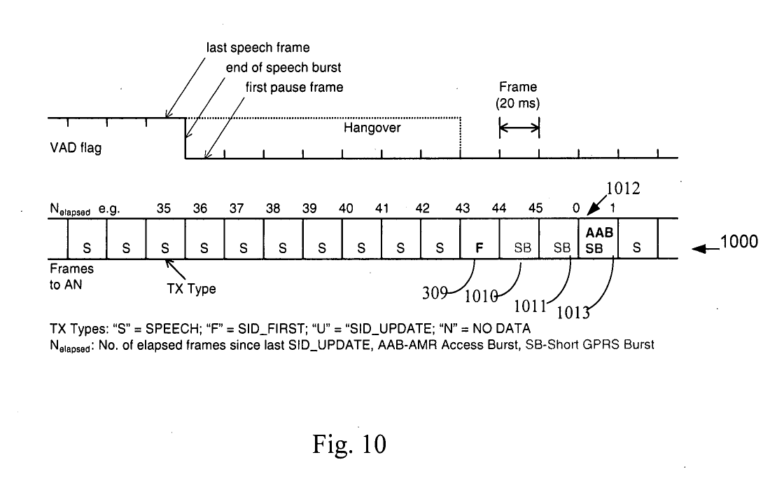

FIGS. 9-10 illustrate an example schematic transmission sequences using an example DTM network 100. Transmission 901 illustrates a conventional GSM transmission sequence, where all “N” AMR frames (911-917) are unused by any user. The “N” (911-917) frames therefore are wasted in the conventional GSM transmission. Transmission 902 illustrates an exemplary transmission sequence where the GPRS Uplink data blocks (921-927) from one user, such as the MS 101, are combined with the AMR pause periods from another user, such as the MS 105. A GERAN system capacity could be significantly increased without introducing any hardware changes for both the network 100 and the MS 101 and 105.

FIG. 10 illustrates an example transmission sequence 1000 employing the process described in FIG. 8. FIG. 10 may be compared with FIG. 3, which illustrates a conventional GSM transmission sequence. In FIG. 3, when an AMR user transmits AMR pauses during speech frame transmissions, the “N” frames 305-307 are unused and therefore wasted for data capacity. In FIG. 10, the exemplary process of FIG. 8 uses the frames indicated after the SID_First 309 to allow a number of short GPRS burst frames (1010-1011), terminated by a multiplexed AAB 1012 and a short GPRS frame 1013. The use of the “N” frames 305-307 formerly wasted results in an enhanced data transmission efficiency.

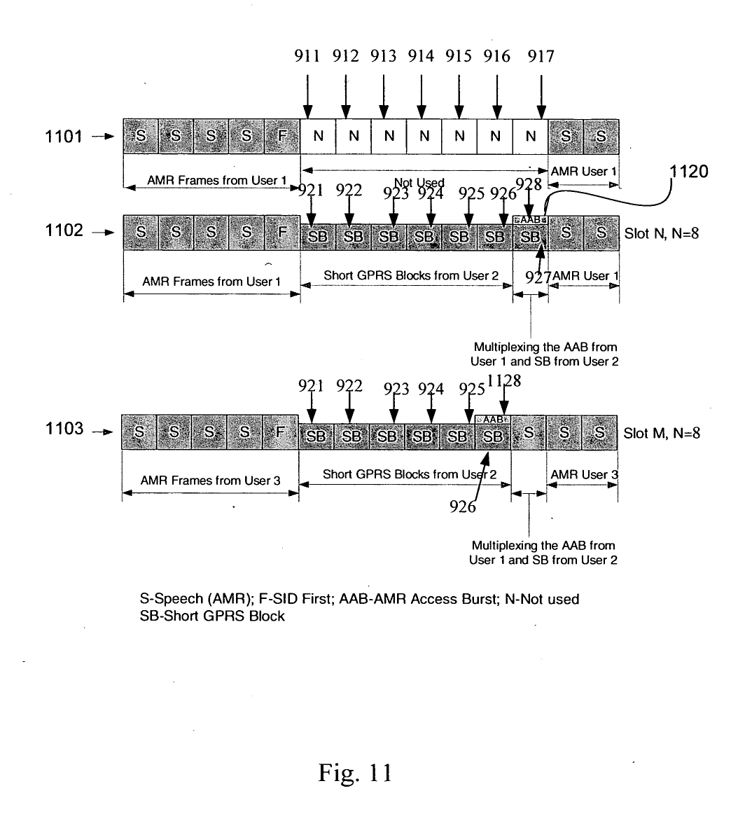

FIG. 11 illustrates example transmission sequences for three users. The communications network 100 may use the AMR pauses from multiple users and combine the pauses with the GPRS data from a PS user. Transmission sequence 1100 shows the AMR transmission frames for a user of speech or circuit-switched services, such as MS 101. The unused frames “N” (911-917) representing AMR pauses from MS 101 are used by a second user, such as the MS 105, represented by a transmission sequence 1102. The MS 105 transmits short GPRS bursts (921-927) during the AMR pause frames (911-917) of the first user MS 101. The network 100 multiplexes the AAB 928 from the first user MS 101, with the GPRS SB 927, at frame 1120. The unused frames may also be used by a third user, such as an additional MS, represented by a transmission sequence 1103. The third user transmits short GPRS bursts (1121-1126) during the AMR pause frames of the first user MS 101. In addition, the third user may transmit AMR speech frames (S). The network 100 multiplexes the AAB 1128 from the third MS with the SB 926 from MS 105 while the third user transmits AMR speech frames as indicated in transmission sequences 1102 and 1103. Multiple users in the GERAN network may thereby take advantage of the multiplexing of AMR pauses from CS users with GPRS short bursts from PS users.

Like the method shown in FIG. 8, the sequence diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the MS 101 or 105, a communication interface, or any other type of non-volatile or volatile memory interfaced or resident to the MS 101 or 105, or the BS 110. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal medium”, and/or “signal-bearing medium: may comprise any module that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While the principles of the invention have been described above in connection with specific apparatus, it is to be clearly understood that this description is made only by way of example and not as a limitation on the scope of the invention. It is therefore intended that the foregoing detailed description be regarded as illustrative rather than limiting, and that it be understood that it is the following claims, including all equivalents, that are intended to define the spirit and scope of this invention.

1. A communications system for a dual transfer mode (DTM) network comprising:
a first mobile system operable to transmit DTM data;
a second mobile system operable to transmit DTM data; and
a network node operable to multiplex an access request burst signal, during an uplink session of a circuit-switched channel, with a short packet-switched data burst associated with the second mobile system, at an end of a pause period from the first mobile system.

2. The communications system of claim 1, where the second mobile system is operable to transmit the short packet-switched data burst during a pause period of the first mobile system.

3. The communications system of claim 1, where the first mobile system and the second mobile system each comprise an adaptive multi-rate audio coding module.

4. The communications system of claim 1, where the transmitted access request burst signal is operable to request a data channel from the DTM network.

5. The communications system of claim 4, where the second mobile system is further operable to transmit the short data burst on a borrowed channel from the first mobile system during the pause period of the other mobile system.

6. The communications system of claim 1, where the DTM network comprises a general packet radio service (GPRS) network.

7. A dual transfer mode (DTM) communications network comprising:
a plurality of mobile systems, the plurality of mobile systems including a transmitting mobile system and a requesting mobile system, operable to:
transmit an access request burst signal at an end of a pause period during an uplink session of a circuit-switched data sequence; and
transmit a short packet-switched data burst associated with the communications device during a pause period of the transmitting mobile system; and
a base station operable to allocate a transmission channel from the transmitting mobile system to the requesting mobile system during the pause period of the transmitting mobile system, and multiplex the access request burst with the short packet-switched data burst at the end of the pause period.

8. The communications device of claim 7, where the mobile system comprises an adaptive multi-rate audio coding module.

9. The communications device of claim 7, where the transmitted access request burst signal comprises a substantially sinusoidal signal.

10. The communications device of claim 7, where the requesting mobile system is further operable to transmit the short data burst on the allocated channel from the transmitting mobile system during the pause period of the transmitting mobile system.

11. The communications device of claim 7, where the DTM network comprises a general packet radio service (GPRS) network.

12. A method that utilizes transmission capacity for a dual transfer mode (DTM) communications device, the method comprising:
transmitting an AMR frame by a transmitting mobile system;
transmitting an access request burst signal by a requesting mobile system on an uplink, at an end of a pause period during an uplink session; and
transmitting a short data burst associated with a mobile system transmitting packet-switched data during a pause period of a transmitting mobile system.

13. The method of claim 12, where transmitting the AMR frame comprises transmitting the AMR frame using an adaptive multi-rate audio coding module.

14. The method of claim 12, where transmitting the access request burst signal comprises requesting a data channel from a DTM network.

15. The method of claim 12, where transmitting the short data burst comprises transmitting the short data burst on a borrowed channel from the requesting mobile system during the pause period of the transmitting mobile system.

16. The method of claim 14, where the DTM network comprises a general packet radio service (GPRS) network.

17. A method that utilizes transmission capacity for a dual transfer mode (DTM) communications network, the method comprising:
transmitting an AMR frame by a transmitting mobile system;
transmitting an access request burst signal by a requesting mobile system at an end of a pause period during an uplink session;
allocating a transmission channel from the transmitting mobile system to the requesting mobile system during the pause period of the transmitting mobile system, based on the access request burst signal;
transmitting a short packet-switched data burst associated with the DTM communications device during a pause period of a transmitting mobile system; and
multiplexing the access request burst signal with the short packet-switched data burst by a DTM network node at the end of the pause period.

18. The method of claim 17, where transmitting the DTM data packet comprises transmitting by the DTM data packet using an adaptive multi-rate audio coding module.

19. The communications device of claim 17, where transmitting the access request burst signal comprises requesting a data channel from the DTM network.

20. The communications device of claim 17, where transmitting the short data burst comprises transmitting the short data burst on a borrowed channel from the transmitting mobile system during the pause period of the transmitting mobile system.

21. The communications device of claim 19, where the DTM network comprises a general packet radio service (GPRS) network.

22. An apparatus that utilizes transmission capacity for a dual transfer mode (DTM) communications device, the apparatus comprising:
means for transmitting an AMR frame by a transmitting mobile system, where the means for transmitting an AMR frame is configured to transmit an access request burst signal by a requesting mobile system on an uplink, at an end of a pause period during an uplink session; and
means for transmitting a short data burst associated with a mobile system transmitting packet-switched data during a pause period of a transmitting mobile system.

23. A communications device for a dual transfer mode (DTM) network comprising:
a network node operable to multiplex an access request burst signal, during an uplink session of a circuit-switched channel, with a short packet-switched data burst from a packet-switched channel at an end of a pause period of the circuit-switched channel.
